(19) United States
(12) Patent Application Publication
(10) Pub. No.: US 2026/0364850 A1
(43) Pub. Date: Nov. 19, 2026

(54) METHOD FOR SEPARATING MULTIPLE SLICES FROM A WORKPIECE BY MEANS OF A WIRE SAW DURING A SEPARATION PROCESS

(71) Applicant: Siltronic AG, Munich (DE)

(72) Inventors: Julian Gotzler, Munich (DE); Daniel Gräf, Mehring (DE)

(21) Appl. No.: 19/135,819

(22) PCT Filed: Dec. 4, 2023
(86) PCT No.: PCT/EP2023/084106

§ 371 Date: Jun. 5, 2025

(30) Foreign Application Priority Data
Dec. 8, 2022 (EP) 22212131.1

(51) Int. Cl. B28D 5/04; B28D 5/00

(52) U.S. Cl. CPC B28D 5/045; B28D 5/0064; B28D 5/0076

(57) ABSTRACT

Wafers are sliced from a workpiece with a wire saw having a wire web of saw wire, which is tensioned in a plane between wire guide rollers. During the cutting, a temperature-control liquid is conducted through a fixed bearing of the rollers based on a temperature profile and/or displacing the workpiece based on a displacement profile. The temperature and displacement profile counteract a shape deviation. Warp curves are ascertained from the workpiece start and an end from at least one preceding slicing operation. The temperature and/or the volumetric flow rate of the cutting agent and temperature control medium are adjusted during the slicing operation in dependence on the difference between the warp curves.

### CROSS REFERENCE TO RELATED APPLICATIONS

This application is a U.S. National Phase application under 35 U.S.C. § 371 of International Application No. PCT/EP 2023/084106, filed on Dec. 4, 2023, and claims benefit to European Patent Application No. EP 22212131.1, filed on Dec. 8, 2022. The International Application was published in German on Jun. 13, 2024 as WO 2024/121052 A 1 under PCT Article 21(2).

### FIELD

The present disclosure provides a method for slicing a multiplicity of wafers from a workpiece a wire saw during a slicing operation.

### BACKGROUND

Methods of slicing wafers from a workpiece by a wire saw are used, for example, in the production of semiconductor wafers, in particular of wafers composed of monocrystalline silicon, and are referred to as MWS (multi-wire slicing) methods. One configuration of such a method provides for the workpiece, for example a cylindrical ingot of monocrystalline silicon, to be fed through wire sections of a saw wire moving in a longitudinal direction, the wire sections being arranged parallel to one another so as to form a wire web, in the presence of a suspension of cutting liquid and hard materials, also called a slurry, and to be cut into wafers in the process.

In the course of the method, heat is generated at different locations on the wire saw and the workpiece, such that the workpiece and the wire web move relative to one another on account of thermal expansion. Such a relative movement results in unevenness of the main faces of the sliced-off wafers. Efforts are being made to alleviate this disadvantageous effect.

US 2012 0 178 346 A1 describes supplying a cooling liquid to the workpiece and wiping the cooling liquid off from the workpiece. It is disclosed that, inter alia, this measure reduces the local warp of sliced-off wafers.

US 2007 0 178 807 A1 proposes adjusting the temperature and/or the volumetric flow rate of a slurry supplied to the workpiece holder and the temperature and/or the volumetric flow rate of the slurry supplied to the wire web in a manner dependent on the cutting depth.

The method described in EP 3 922 386 A1 comprises supplying a slurry to the wire web, wetting the workpiece with a cooling medium and controlling the temperature of the fixed bearing of the wire guide rollers with a cooling liquid. The temperature of the cooling medium and the temperature of the cooling liquid follow the specification of a respective temperature profile which specifies the temperature of the cooling medium and, respectively, of the cooling liquid in dependence on the cutting depth and counteracts a shape deviation from a planar target shape ascertained on previously sliced-off wafers. As an alternative or in addition to controlling the temperature of the fixed bearing, displacement of the workpiece along the workpiece axis by means of an actuating element is suggested, the profile of the displacement travel counteracting the shape deviation. The shape deviation of wafers produced in this way, illustrated in the form of an averaged warp curve, is comparatively low. That method, its alternative and the combination of both is referred to hereinbelow as a method for correcting the average warp.

During a slicing operation, the workpiece is heating up and temporarily expands as a result. The change in distance between a wire section and the closest workpiece end side is all the greater the shorter the distance between the wire section and this workpiece end side at the beginning of the slicing operation. If the workpiece start is defined as that end side of the workpiece which has the smallest distance from the wire web at the point where the saw wire runs into the wire web, and the workpiece end is defined as that end side of the workpiece which has the smallest distance from the wire web at the point where the saw wire runs out of the wire web, it is clear that wafers having the shortest distance from the workpiece start and from the workpiece end exhibit the greatest warp owing to the thermal expansion of the workpiece. In addition, such wafers have an inverse shape. The shape of a wafer sliced off near to the workpiece start is concave, and that of a wafer sliced off near to the workpiece end is convex.

If the shape deviation is reduced by controlling the temperature of the fixed bearing and/or by displacing the workpiece, and if diagrams plotting warp curves of wafers that are sliced off at the ends are superimposed, a cluster of curves is obtained that resembles the contour of a wrapped candy. Owing to the mentioned inverse nature, the variation in the warp curves is greatest at the cut-in, at the middle of the cut and at the cut-out.

### SUMMARY

In an embodiment, the present disclosure provides a method for slicing a plurality of wafers from a workpiece with a wire saw during a slicing operation. The wire saw has: a wire web of moving wire sections of a saw wire; and a feed unit. The wire web is tensioned in a plane between two wire guide rollers, each of the two wire guide rollers being supported between a fixed bearing and a floating bearing. The method includes: feeding the workpiece through the wire web along a feed direction perpendicular to a workpiece axis and perpendicular to the plane of the wire web with the feed unit; supplying a cutting agent to the wire web; supplying a temperature-control medium to the workpiece; conducting a temperature-control liquid through the fixed bearing in accordance with a temperature profile and/or displacing the workpiece along the workpiece axis in accordance with a displacement profile, the temperature profile and the displacement profile counteracting a shape deviation; ascertaining warp curves of at least one wafer from the workpiece start and of at least one wafer from the workpiece end from at least one preceding slicing operation using the wire saw; forming the difference between the warp curves; adjusting the temperature and/or the volumetric flow rate of the cutting agent during the slicing operation in dependence on the difference between the warp curves; and adjusting the temperature and/or the volumetric flow rate of the temperature-control medium in dependence on the difference between the warp curves.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows the cutting profile of saw wires of the wire web through a workpiece, which results from the thermal expansion during the sawing process in spite of application of a method for correcting the average warp;

FIG. 2 shows: (top) an overview of typical warp curves of wafers from the workpiece start and from the workpiece end; (middle) averaged warp curves of wafers from the workpiece start and from the workpiece end; (bottom) the difference between the averaged warp curves from the workpiece start and from the workpiece end;

FIG. 3 shows: (left half) profiles of the volumetric flow rate (top) and of the temperature (bottom) of the cutting agent in dependence on the cutting depth; (right half) profiles of the volumetric flow rate (top) and of the temperature (bottom) of the temperature-control medium in dependence on the cutting depth; and

FIG. 4 shows: (top) the variation of superimposed warp curves of wafers from the workpiece start and from the workpiece end, the wafers having been sliced from a workpiece without use of aspects from the present disclosure; and (bottom) the variation of superimposed warp curves of wafers from the workpiece start and from the workpiece end, the wafers having been sliced from a workpiece which has been cut into wafers in the manner according to disclosed aspects of the present disclosure.

### DETAILED DESCRIPTION

Aspects of the present disclosure provide a method for slicing a multiplicity of wafers from a workpiece a wire saw during a slicing operation.

The wire saw includes a wire web of moving wire sections of a saw wire and a feed unit. The wire web is tensioned in a plane between two wire guide rollers, each of the two wire guide rollers being supported between a fixed bearing and a floating bearing.

A method according to the present disclosure includes: feeding the workpiece through the wire web along a feed direction perpendicular to a workpiece axis and perpendicular to the plane of the wire web by means of the feed unit; supplying a cutting agent to the wire web; supplying a temperature-control medium to the workpiece; conducting a temperature-control liquid through the fixed bearing in accordance with a temperature profile and/or displacing the workpiece along the workpiece axis in accordance with a displacement profile, the temperature profile and the displacement profile counteracting a shape deviation; ascertaining warp curves of at least one wafer from the workpiece start and of at least one wafer from the workpiece end from at least one preceding slicing operation using the wire saw; forming the difference between the warp curves; adjusting the temperature and/or the volumetric flow rate of the cutting agent during the slicing operation in dependence on the difference between the warp curves; and adjusting the temperature and/or the volumetric flow rate of the temperature-control medium in dependence on the difference between the warp curves.

In order to control the temperature of the workpiece during the slicing operation, the method may use wire saw-specific data because they are provided by wafers which have been produced using the same wire saw. The wire saw comprises two or more wire guide rollers. A respective warp curve in a cutting direction along the diameter of the wafers in one or more slicing operations that precede the slicing operation using the wire saw is ascertained. At least two wafers are selected, which originate from the workpiece start and from the workpiece end. Warp curves of one or more wafers from the workpiece start and of one or more wafers from the workpiece end are averaged to form a respective common warp curve which represents a wafer from the workpiece start and, respectively, a wafer from the workpiece end. The difference between the warp curves of one or more wafers from the workpiece end and from the workpiece start in at least one preceding slicing operation is subsequently formed. If the difference between the warp curves is based on warp curves that originate from wafers from the workpiece start and from the workpiece end in a plurality of preceding slicing operations, warp curves of wafers from the workpiece start and, respectively, of wafers from the workpiece end are averaged to form a respective warp curve prior to the difference formation. The adjustment of the temperature and/or the adjustment of the volumetric flow rate of the cutting agent and of the temperature-control medium during the slicing operation is based on the difference between the warp curves. The temperature and/or the volumetric flow rate of the cutting agent and of the temperature-control medium are specified in dependence on the difference between the warp curves, the temperature-control power being able to be divided differently between the cutting agent and the temperature-control medium. In a preferred embodiment, there is an overweighting of temperature-control power towards the temperature-control medium at the start of the slicing operation and an overweighting of temperature-control power towards the cutting agent at the end of the slicing operation, because the lateral surface of the workpiece that is able to be covered with the temperature-control medium decreases as the cutting depth increases.

If the difference between the warp curves is positive at a determined cutting depth, more heat can be supplied to the workpiece relative to the heat supply in the case of a difference of zero. If the difference between the warp curves is negative at a determined cutting depth, more heat can be drawn from the workpiece relative to the heat supply in the case of a difference of zero. It is possible to respond to a negative difference between the warp curves with decreasing temperature of the cutting agent, with increasing volumetric flow rate of the cutting agent, with decreasing temperature of the temperature-control medium or with increasing volumetric flow rate of the temperature-control medium. Correspondingly, it is possible to respond to a positive difference between the warp curves with increasing temperature of the cutting agent, with decreasing volumetric flow rate of the cutting agent, with increasing temperature of the temperature-control medium or with decreasing volumetric flow rate of the temperature-control medium. A combination of one or more of these response possibilities can be selected. In particular, after a cutting depth of not more than 85% has been reached, the temperature-control medium is being discontinued and the supply of the temperature-control medium is being adjusted.

It is of course also possible for the difference between the warp curves to be formed from one or more wafers from the workpiece start and from one or more wafers from the workpiece end. The difference then has a reversed sign and is correspondingly responded to in reversed fashion. For example, in the case of a positive difference, less heat is supplied to the workpiece relative to the heat supply in the case of a difference of zero. Correspondingly, a positive difference between the warp curves is responded to with one or more of these measures: with a decreasing temperature of the cutting agent, with an increasing volumetric flow rate of the cutting agent, with a decreasing temperature of the temperature-control medium and with an increasing volumetric flow rate of the temperature-control medium.

On account of the proposed manner of supply of cutting agent and temperature-control medium, the shape of the wafers in the slicing operation, expressed as warp curve, varies to a significantly lesser extent than in the case without this measure.

The cutting agent is a slurry, that is to say a suspension of hard material particles in a liquid. The temperature-control medium may be this slurry, a slurry of different composition or a liquid without hard material particles contained therein.

The conducting of the temperature-control liquid through the fixed bearing and/or the displacing of the workpiece along the workpiece axis influences the appearance of the wafers in the slicing operation, expressed as averaged warp curve after averaging of the warp curves of the wafers. The temperature of the temperature-control liquid in dependence on the cutting depth follows a temperature profile, which counteracts a shape deviation, and causes axial displacement of the floating bearing by means of thermal expansion or thermal contraction of the fixed bearing. Correspondingly, the displacement of the workpiece in dependence on the cutting depth follows a displacement profile which specifies the direction and the magnitude of the displacement and counteracts the shape deviation. In a preferred embodiment, the temperature profile and/or the displacement profile counteract a shape deviation indicated by an averaged warp curve of wafers that have been sliced off during the at least one preceding slicing operation, or a shape deviation as defined in EP 3 922 386 A1. The conducting of the temperature-control liquid through the fixed bearing according to the specification of the temperature profile and the displacing of the workpiece along the workpiece axis according to the specification of the displacement profile can be carried out simultaneously. It is also possible for the one or the other to be omitted.

In addition, preference is given to ensuring that the cutting agent and the temperature-control medium influence one another as little as possible by wiping the temperature-control medium off from the workpiece and discharging it before it can fall onto the wire web. This may for example be carried out as described in US 2012 0 178 346 A1

The expression “warp of a wafer” refers to the sum of the values of the greatest distances upward and downward between a reference plane and a median surface of the relaxed wafer, the reference plane being a plane of best fit with respect to the median surface. The measurement of warp is described in the Standard SEMI MF1390. The warp curve (linear shape scan) corresponds to the one-dimensional profile obtained when the difference between the median curve of the median surface and the reference straight line of the reference plane along the diameter is observed, preferably in the cutting direction or deviating up to a few degrees therefrom if the influence of an orientation notch is to be avoided. The influence of gravity on the warp curve can be taken into account by vertical arrangement of the wafer when measuring the warp or by a correction when calculating the difference. The warp curves may be filtered or subjected to another mathematical operation, provided that the resultant changes cancel each other out in the warp curve difference formation according to the present disclosure.

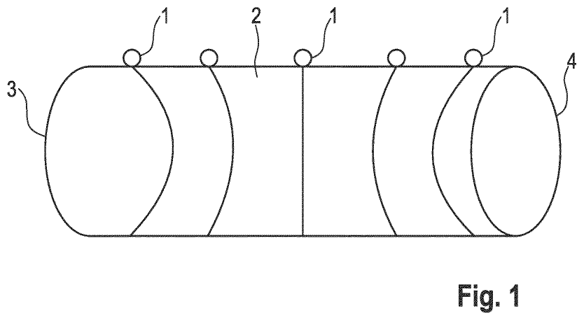

FIG. 1 schematically shows the cutting profile of wire sections 1 of the wire web through a workpiece 2, which results from the thermal expansion during the sawing process. If the wafers obtained are rotated 90° clockwise, wafers from the workpiece start 3 have a concave shape and wafers from the workpiece end 4 have a convex wafer shape.

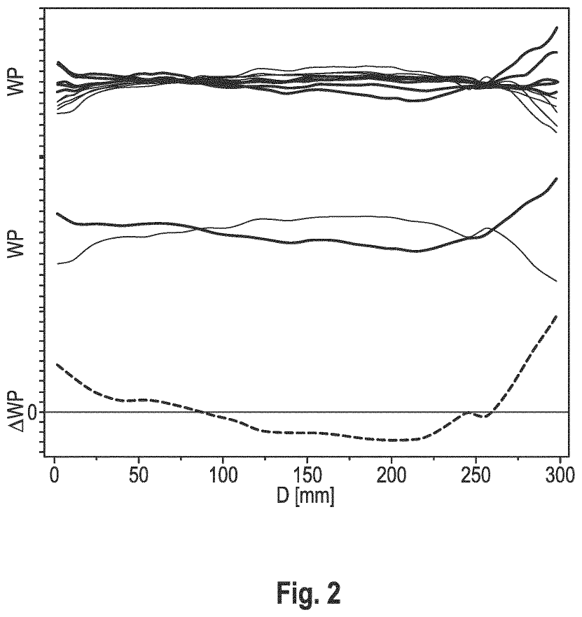

FIG. 2 (top) shows typical warp curves WP of wafers from the workpiece start and from the workpiece end. The warp curves were ascertained using a capacitively operating measuring device of the MX 7012 type from E+H Metrology GmbH, Germany. The variation of the warp curves is particularly pronounced at the start, in the middle and at the end of the slicing operation. FIG. 2 (middle) shows two warp curves obtained by averaging, which represent wafers from the workpiece start and from the workpiece end, and FIG. 2 (bottom) shows the difference AWP between these warp curves.

The temperature of the cutting agent and the temperature of the temperature-control medium and/or the volumetric flow rate at which the cutting agent is fed to the wire web and the temperature-control medium is fed to the workpiece during a slicing operation are based on such a warp curve difference, thus are dependent on data ascertained after at least one preceding slicing operation.

In the case of a difference of zero, the temperature or volumetric flow rate respectively provided for the process is adjusted, in the case of a positive difference a correspondingly higher temperature or lower volumetric flow rate, and in the case of a negative difference a correspondingly lower temperature or higher flow rate.

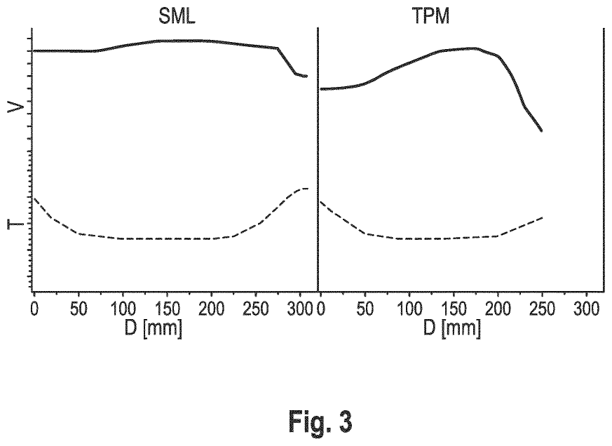

FIG. 3 shows, as an example, profiles of the volumetric flow rate V (top) and of the temperature T (bottom) of the cutting agent SML (left half) and of the temperature-control medium TPM (right half) in dependence on the cutting depth D. Silicon semiconductor wafers were sliced from a single crystal. The profiles are based on the difference between the warp curves, which is illustrated in FIG. 2 (bottom). The difference is greater than zero at the start and at the end of the cutting profile, and smaller than zero at a middle cutting depth. The profiles of temperature and volumetric flow rate according to FIG. 3 are consistent with this. Thus, the volumetric flow rate of the cutting agent is adjusted to be comparatively high and the temperature of the cutting agent is adjusted to be comparatively low during a middle cutting depth. The same applies to the volumetric flow rate and the temperature of the temperature-control medium. The temperature-control power of the cutting agent and of the temperature-control medium have different weight during the cutting profile. Toward the end of the cutting profile, the temperature-control power lies completely on the side of the cutting agent, because at that point temperature-control medium is no longer supplied to the workpiece.

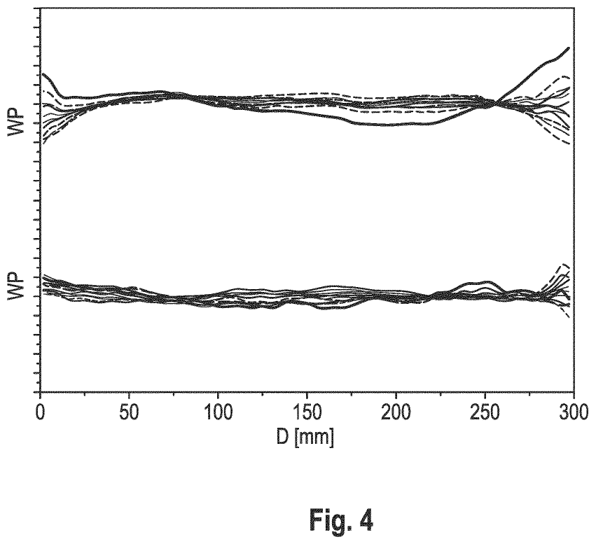

FIG. 4 shows, in relation to simultaneously illustrated warp curves from the workpiece start and from the workpiece end, the difference between the method according to the present disclosure (bottom) and a method (top) which does not adjust temperature and/or volumetric flow rate of cutting agent and temperature-control medium in dependence on the warp curve difference. In the case of the application of the method according to the present disclosure, the variation of the warp curves is considerably less pronounced particularly at the beginning, in the middle and at the end of the cutting profile.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE DESIGNATIONS USED

1 Wire sections
2 Workpiece
3 Workpiece start
4 Workpiece end
D Cutting depth
WP Warp curves
AWP Warp curve difference
V Volumetric flow rate
T Temperature
SML Cutting agent
TPM Temperature-control medium

1. A method for slicing a plurality of wafers from a workpiece with a wire saw during a slicing operation, the wire saw comprising: a wire web of moving wire sections of a saw wire; and a feed unit, and the wire web being tensioned in a plane between two wire guide rollers, each of the two wire guide rollers being supported between a fixed bearing and a floating bearing, the method comprising:
feeding the workpiece through the wire web along a feed direction perpendicular to a workpiece axis and perpendicular to the plane of the wire web with the feed unit;
supplying a cutting agent to the wire web;
supplying a temperature-control medium to the workpiece;
conducting a temperature-control liquid through the fixed bearing in accordance with a temperature profile and/or displacing the workpiece along the workpiece axis in accordance with a displacement profile, the temperature profile and the displacement profile counteracting a shape deviation;
ascertaining warp curves of at least one wafer from the workpiece start and of at least one wafer from the workpiece end from at least one preceding slicing operation using the wire saw;
forming the difference between the warp curves;
adjusting the temperature and/or the volumetric flow rate of the cutting agent during the slicing operation in dependence on the difference between the warp curves; and
adjusting the temperature and/or the volumetric flow rate of the temperature-control medium in dependence on the difference between the warp curves.

2. The method as claimed in claim 1, the method further comprising overweighting of temperature-control power towards the temperature-control medium at the start of the slicing operation and of temperature-control power towards the cutting agent at the end of the slicing operation.

3. The method as claimed in claim 1, the method further comprising wiping the temperature-control medium off from the workpiece.

4. The method as claimed in claim 1, wherein an averaged warp curve of wafers that have been sliced off during the at least one preceding slicing operation indicates the shape deviation.

5. The method as claimed in claim 1, wherein, after a cutting depth of not less than 85% has been reached, the supply of the temperature-control medium to the workpiece is discontinued.

6. The method as claimed in claim 1, wherein the difference between the warp curves is based on warp curves that originate from wafers from the workpiece start and from the workpiece end in a plurality of preceding slicing operations, warp curves of wafers from the workpiece start and, respectively, of wafers from the workpiece end being averaged to form a respective warp curve prior to the difference formation.
